(19) United States
(12) Patent Application Publication
(10) Pub. No.: US 2023/0396774 A1
(43) Pub. Date: Dec. 7, 2023

(54) METHODS, APPARATUSES AND COMPUTER PROGRAM PRODUCTS FOR PROVIDING UNIFIED ARCHITECTURE FOR PROVIDING BI PREDICTION IN FRACTIONAL MOTION ESTIMATION ENGINES SUPPORTING MULTIPLE CODECS

(71) Applicant: META PLATFORMS, INC., Menlo Park, CA (US)

(72) Inventors: Kameswara Kishore Sriadibhatla, Dublin, CA (US); Yunqing Chen, Los Altos, CA (US); Anil Muthiraparampil Sunil, San Jose, CA (US); Adrian Stafford Lewis, Mountain View, CA (US)

(21) Appl. No.: 18/061,162

(22) Filed: Dec. 2, 2022

Related U.S. Application Data
(60) Provisional application No. 63/347,751, filed on Jun. 1, 2022.

(51) Int. Cl. H04N 19/137; H04N 19/132; H04N 19/105; H04N 19/182

(52) U.S. Cl. CPC H04N 19/137; H04N 19/132; H04N 19/105; H04N 19/182

(57) ABSTRACT

A system for providing a unified architecture for performing bi-prediction in fractional motion estimation engines is disclosed. The system may receive one or more source pixels and reference pixels. The source pixels may be associated with one or more source image frames and the reference pixels may be associated with one or more reference image frames. The system may utilize motion vector information associated with the source pixels and the reference pixels to determine a plurality of fractional image samples associated with the one or more source image frames and the one or more reference image frames. The system may determine, based on the motion vector information, a unidirectional prediction relating to a motion estimation of at least one of the references image frames. The system may determine, based on the unidirectional prediction, a bi-prediction motion estimate associated with the at least one reference image frame.

### CROSS-REFERENCE TO RELATED APPLICATIONS

This application claims the benefit of U.S. Provisional Application No. 63/347,751 filed Jun. 1, 2022, entitled “Methods, Apparatuses And Computer Program Products For Providing Unified Architecture For Providing Bi Prediction In Fractional Motion Estimation Engines Supporting Multiple Codecs,” the entire content of which is incorporated herein by reference.

### TECHNOLOGICAL FIELD

Exemplary embodiments of this disclosure relate generally to methods, apparatuses and computer program products for providing a unified architecture for performing bi-prediction in fractional motion estimation engines.

### BACKGROUND

Motion estimation is an important operation in video encoding and fractional motion estimation (FME) may be performed to refine the motion vector (MV) to sub-pixel accuracy. The approach of using fractional motion estimation to refine a motion vector is computationally intensive and a complex operation due to the interpolation of all sub-pixel samples and the corresponding distortion computation for multiple reference frames (e.g., frames of images) and partition sizes of prediction units (PUs). Bi-prediction is an important technique to further improve the encoding efficiency. In bi-prediction, the current PU may be predicted based on the PUs from two different reference frames by averaging the samples.

In view of the foregoing drawbacks, it may be beneficial to provide a unified architecture for the computationally intensive bi-prediction operation which supports multiple codecs as well as meets high throughput and quality requirements.

### BRIEF SUMMARY

Exemplary embodiments are described for providing a unified architecture for performing bi-prediction in fractional motion estimation engines which may support multiple video codecs.

The exemplary embodiments may provide hardware friendly algorithm optimizations. During a bi-prediction operation, in existing techniques, each reference pair (e.g., reference pairs of images) typically may need to go through multiple dependent iterations before determining a final motion vector pair. To address these drawbacks, the exemplary embodiments may provide a hardware friendly unified architecture in which the number of iterations for each reference pair may be programmable and the data dependency between the reference pair may be removed.

Additionally, the exemplary embodiments may provide scalable and configurable architecture. For example, a number of reference frame pairs and a number of iterations within each reference frame pair may be configured depending on performance/quality requirements. The architecture may be scalable by the exemplary embodiments to support larger partition sizes such as, for example, 128×128 which may be required for newer codecs such as, for example, Alliance for Open Media Video 1 (AV1).

The exemplary embodiments may also provide memory optimization. For example, one of the reference frames that may be required for bi-prediction may be recomputed by the exemplary embodiments in real-time (e.g., on the fly) using the motion vector information from a single prediction determination to reduce memory space (for example in a memory device). In an instance in which a frame is not recomputed, such as in existing approaches, reference pixels for all fractional motion vectors for an entire superblock (SB) may need to be saved to a memory device during single prediction which typically requires huge memory space. A superblock may refer to a block of pixels (e.g., typically 128×128 or 64×64 or 16×16) that the frame is divided into. A superblock may be further subdivided into sub-partitions.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary video encoder in accordance with an exemplary embodiment.

FIG. 2 is a diagram of an exemplary fractional motion estimation engine in accordance with an exemplary embodiment.

FIG. 3 is a diagram illustrating frames associated with an exemplary bi-prediction structure determination relating to the VP9 video codec in accordance with an exemplary embodiment.

FIG. 4 is a diagram illustrating frames associated with an exemplary bi-prediction structure determination relating to the H.264 video codec in accordance with an exemplary embodiment.

FIG. 5 is a diagram illustrating an exemplary manner in which two frames may be utilized for bi-prediction in accordance with an exemplary embodiment.

FIG. 6 is a diagram of an exemplary computing system in accordance with an exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It is to be understood that the methods and systems described herein are not limited to specific methods, specific components, or to particular implementations. It is also to be understood that the terminology used herein is for the purpose of describing particular embodiments only and is not intended to be limiting.

### Exemplary Video Encoder

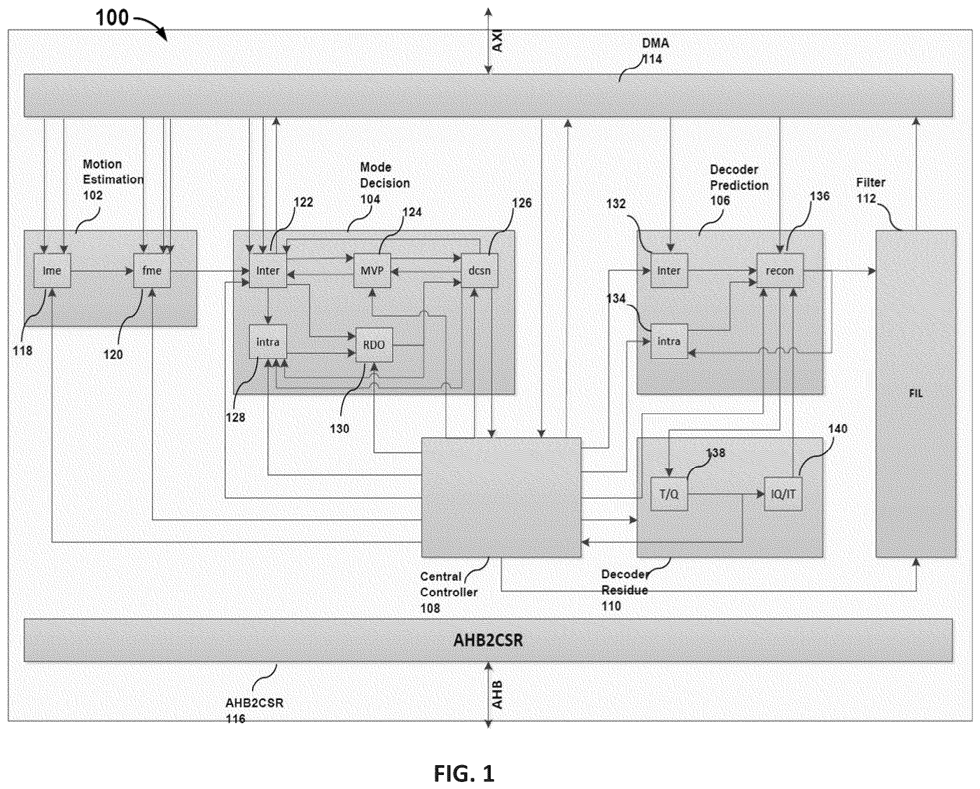

FIG. 1 illustrates a block diagram of an embodiment of a video encoder 100. For example, video encoder 100 supports the video coding format AV1 (Alliance for Open Media Video 1). However, video encoder 100 may also support other video coding formats as well, such as H.262 (NDEG-2 Part 2), MPEG-4 Part 2, H.264 (MPEG-4 Part 10), HEVC, (H.265), Theora, RealVideo RV40, and VP9.

Video encoder 100 includes many modules. Some of the main modules of video encoder 100 are shown in FIG. 1. As shown in FIG. 1, video encoder 100 includes a direct memory access (DMA) controller 114 for transferring video data. Video encoder 100 also includes an AMBA (Advanced Microcontroller Bus Architecture) to CSR (control and status register) module 116. Other main modules include a motion estimation module 102, a mode decision module 104, a decoder prediction module 106, a central controller 108, a decoder residue module 110, and a filter 112.

Video encoder 100 includes a central controller module 108 that controls the different modules of video encoder 100, including motion estimation module 102, mode decision module 104, decoder prediction module 106, decoder residue module 110, filter 112, and DMA controller 114.

Video encoder 100 includes a motion estimation module 102. Motion estimation module 102 includes an integer motion estimation (IME) module 118 and a fractional motion estimation (FME) module 120. Motion estimation module 102 determines motion vectors that describe the transformation from one image to another, for example, from one frame to an adjacent frame. A motion vector is a two-dimensional vector used for inter-frame prediction; it refers the current frame to the reference frame, and its coordinate values provide the coordinate offsets from a location in the current frame to a location in the reference frame. Motion estimation module 102 estimates the best motion vector, which may be used for inter prediction in mode decision module 104. An inter coded frame is divided into blocks, e.g., prediction units or partitions within a macroblock. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference frame. The process of motion vector determination is called motion estimation.

Video encoder 100 includes a mode decision module 104. The main components of mode decision module 104 include an inter prediction module 122, an intra prediction module 128, a motion vector prediction module 124, a rate-distortion optimization (RDO) module 130, and a decision module 126. Mode decision module 104 determines one prediction mode among a number of candidate inter prediction modes and intra prediction modes that gives the best results for encoding a block of video.

Intra prediction is the process of deriving the prediction value for the current sample using previously decoded sample values in the same decoded frame. Intra prediction exploits spatial redundancy, i.e., correlation among pixels within one frame, by calculating prediction values through extrapolation from already coded pixels for effective delta coding. Inter prediction is the process of deriving the prediction value for the current frame using previously encoded reference frames. Inter prediction exploits temporal redundancy.

Rate-distortion optimization (RDO) is the optimization of the amount of distortion (loss of video quality) against the amount of data required to encode the video, i.e., the rate. RDO module 130 provides a video quality metric that measures both the deviation from the source material and the bit cost for each possible decision outcome. Both inter prediction and intra prediction have different candidate prediction modes, and inter prediction and intra prediction that are performed under different prediction modes may result in final pixels requiring different rates and having different amounts of distortion and other costs.

For example, different prediction modes may use different block sizes for prediction. In some parts of the image there may be a large region that can all be predicted at the same time (e.g., a still background image), while in other parts there may be some fine details that are changing (e.g., in a talking head) and a smaller block size would be appropriate. Therefore, some video coding formats provide the ability to vary the block size to handle a range of prediction sizes. The decoder decodes each image in units of superblocks (e.g., 128×128 or 64×64 pixel superblocks). Each superblock has a partition that specifies how it is to be encoded. Superblocks may be divided into smaller blocks according to different partitioning patterns. This allows superblocks to be divided into partitions as small as 4×4 pixels.

Besides using different block sizes for prediction, different prediction modes may use different settings in inter prediction and intra prediction. For example, there are different inter prediction modes corresponding to using different reference frames, which have different motion vectors. For intra prediction, the intra prediction modes depend on the neighboring pixels, and AV1 uses eight main directional modes, and each allows a supplementary signal to tune the prediction angle in units of 3°. In VP9, the modes include DC, Vertical, Horizontal, TM (True Motion), Horizontal Up, Left Diagonal, Vertical Right, Vertical Left, Right Diagonal, and Horizontal Down.

RDO module 130 receives the output of inter prediction module 122 corresponding to each of the inter prediction modes and determines their corresponding amounts of distortion and rates, which are sent to decision module 126. Similarly, RDO module 130 receives the output of intra prediction module 128 corresponding to each of the intra prediction modes and determines their corresponding amounts of distortion and rates, which are also sent to decision module 126.

In some embodiments, for each prediction mode, inter prediction module 122 or intra prediction module 128 predicts the pixels, and the residual data (i.e., the differences between the original pixels and the predicted pixels) may be sent to RDO module 130, such that RDO module 130 may determine the corresponding amount of distortion and rate. For example, RDO module 130 may estimate the amounts of distortion and rates corresponding to each prediction mode by estimating the final results after additional processing steps (e.g., applying transforms and quantization) are performed on the outputs of inter prediction module 122 and intra prediction module 128.

Decision module 126 evaluates the cost corresponding to each inter prediction mode and intra prediction mode. The cost is based at least in part on the amount of distortion and the rate associated with the particular prediction mode. In some embodiments, the cost (also referred to as rate distortion cost, or RD Cost) may be a linear combination of the amount of distortion and the rate associated with the particular prediction mode; for example, RD Cost=distortion+λ*rate, where λ is a Lagrangian multiplier. The rate includes different components, including the coefficient rate, mode rate, partition rate, and token cost/probability. Other additional costs may include the cost of sending a motion vector in the bit stream. Decision module 126 selects the best inter prediction mode that has the lowest overall cost among all the inter prediction modes. In addition, decision module 126 selects the best intra prediction mode that has the lowest overall cost among all the intra prediction modes. Decision module 126 then selects the best prediction mode (intra or inter) that has the lowest overall cost among all the prediction modes. The selected prediction mode is the best mode detected by mode decision module 104.

After the best prediction mode is selected by mode decision module 104, the selected best prediction mode is sent to central controller 108. Central controller 108 controls decoder prediction module 106, decoder residue module 110, and filter 112 to perform a number of steps using the mode selected by mode decision module 104. This generates the inputs to an entropy coder that generates the final bitstream. Decoder prediction module 106 includes an inter prediction module 132, an intra prediction module 134, and a reconstruction module 136. If the selected mode is an inter prediction mode, then the inter prediction module 132 is used to do the inter prediction, whereas if the selected mode is an intra prediction mode, then the intra prediction module 134 is used to do the intra prediction. Decoder residue module 110 includes a transform and quantization module (T/Q) 138 and an inverse quantization and inverse transform module (IQ/IT) 140.

Fractional motion estimation is performed to refine the motion vectors to sub-pixel accuracy, which is a key technique for achieving significant compression gains in different video coding, formats, including H.264, VP9, and AV1. Either Quarter-pixel or one-eighth pixel fractional motion estimation is supported depending on the codec type (H.264, VP9, or AV1). However, FME is computationally intensive because it involves interpolation of all sub-pixel samples and computation of their corresponding distortion for multiple reference frames and prediction units (PUs). A PU is the most basic unit of prediction and it may be either a square (N×N) or a rectangle (2N×N or N×2N). For example, in H.264, 4×4, 8×8, 16×8, 8×16, and 16×16 PUs are supported. In VP9, 4×4, 8×8, 16×16, 32×16, 16×32, 32×32, 32×64, 64×32, and 64×64 PUs are supported. In addition, H.264 or VP9 video encoding for data center applications has high throughput and quality requirements. For example, for live cases, 4K @ 60 frame per second (fps) is supported. For Video On Demand (VOD) cases, 4K @ 15 fps is supported. Therefore, it would be desirable to design a high throughput, quality preserving FME hardware engine that meets the encoder performance and quality requirements.

In the present application, a video encoder 100 is disclosed. The video encoder comprises an integer level motion estimation hardware component configured to determine candidate integer level motion vectors for a video being encoded. The video encoder further comprises a fractional motion estimation hardware component configured to receive the candidate integer level motion vectors from the integer motion estimation hardware component and refine the candidate integer level motion vectors into candidate sub-pixel level motion vectors, wherein the fractional motion estimation hardware component includes a plurality of parallel pipelines configured to process coding units of a frame of the video in parallel across the plurality of parallel pipelines. The integer level motion estimation hardware component and the fractional motion estimation hardware component may be a part of an application-specific integrated circuit (ASIC).

Inter-frame prediction techniques may be utilized by the video encoder 100 of the exemplary embodiments to remove temporal redundancy. As described above, motion estimation may be an important operation in video encoding and fractional motion estimation may be performed to refine the motion vector to sub-pixel accuracy. This may be a computationally intensive and complex operation due to interpolation of all sub-pixel samples and the corresponding distortion computation for multiple reference frames and prediction units. Bi prediction may be an important technique to further improve the encoding efficiency. In bi-prediction, a current PU may be predicted based on prediction units from two different reference frames by averaging the samples (e.g., samples of images). The exemplary embodiments may provide a unified architecture for the computationally intensive bi-prediction operation which may support multiple codecs as well as meets high throughput and quality requirements.

### Scalable and Configurable Architecture

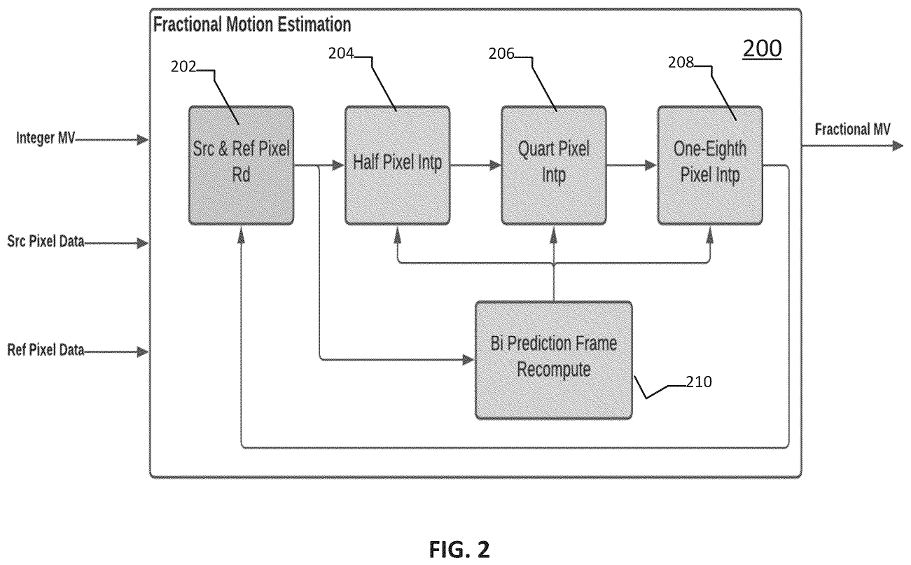

FIG. 2 illustrates an exemplary fractional motion estimation engine 200. In some exemplary embodiments, the fractional motion estimation engine 200 (also referred to herein as FME engine 200) may be an example of the fractional motion estimation module 120.

The FME engine 200 may compute the best fractional motion vector for every prediction unit associated with a frame (e.g., an image frame) by evaluating multiple reference frames. The reference frames may be associated with multiple reference image frames. As described above a PU may be the most basic unit of prediction and a prediction unit may be either a square (N×N) or a rectangle (2N×N,N×2N). For example, in the H.264 (MPEG-4 Part 2) standard, 4×4, 4×8, 8×4, 8×8, 16×8, 8×16, and 16×16 PUs may be specified. In VP9, 4×4, 4×8, 8×4, 8×8, 8×16, 16×8, 16×16, 32×16, 16×32, 32×32, 32×64, 64×32, and 64×64 PUs may be specified.

The FME engine 200 may support all the above shapes and a programmable number of reference frame pairs for bi-prediction. Additionally, the FME engine 200 may be scalable, supporting newer standards like AV1, which may require support for bigger PUs like 64×128, 128×64 and 128×128.

Determining all the fractional samples (e.g., of image frames) may be computationally intensive and therefore may consume a lot of power. Instead, nine positions may searched by the FME engine 200 in both half-pixel refinement, e.g., by module 204, (e.g., one integer-pixel search center pointed to by an integer motion vector and eight half-pixel positions surrounding the integer center) and then a quarter-pixel refinement, by module 206, (e.g., the best half-pixel position and eight quarter-pixel positions surrounding the half-pixel center) and an eighth-pixel refinement, by module 208 (e.g., the best quarter-pixel position and eight one-eighth pixel positions surrounding the quarter-pixel center). This approach of the FME engine 200 is more power efficient than brute-force evaluation of all the fractional samples and may have only a marginal drop in quality.

As shown in FIG. 2, the FME engine 200 includes a Source (Src) & Reference (Ref) Pixel Read (Rd) module 202 which may fetch source and reference pixels associated with one or more source/reference image frames. The source/reference image frames may be associated with a video(s). The pipelined Half-Pixel Interpolation (Intp) module 204, Quarter-Pixel Interpolation module 206, and the One-Eight-Pixel Interpolation module 208 may each determine the half, quarter, and one-eight resolution fractional samples respectively. The pipelined Half-Pixel Interpolation module 204, Quarter-Pixel Interpolation module 206, and One-Eight-Pixel Interpolation module 208 may also determine the cost associated with each fractional position, and may determine the winner and may send the winner on to the next module (e.g., one of modules 204, 206, 208). For bi-prediction, two reference frames are typically required. The bi-prediction frame recompute module 210 recomputes one of the reference frames required for bi-prediction on the fly (e.g., in real-time) using the motion vector information from the unidirectional prediction determination.

Fractional interpolation may require extra samples surrounding the prediction unit being upsampled. The number of extra samples may depend on the filter length. VP9 may use 8-tap filtering and H.264 may use 6-tap filtering. For example, to process a 4×4 prediction unit in VP9, the FME engine 200 may need to fetch 12×12 reference pixel data and for 16×16, the FME engine 20 may need to fetch up to 24×24 reference pixel data.

The exemplary embodiments may split prediction units into smaller blocks and process these smaller blocks. For example, the FME engine 200 may process prediction units in chunks of 8×4 (e.g., 32 pixels) per clock cycle. Splitting into smaller chunks like 8×4 may help in having unified memory interface for all clients (e.g., client devices) and may simplify the DMA design as well. Other block sizes like 8×2 (e.g., 16 pixels/clock cycle) are also possible depending on the system requirements. As such, an 8×8 prediction unit may require fetching 16×16 pixels because of 8 tap filtering required in FME which translates to 16×16/8×4=8 8×4 blocks; a 16×16 PU may require the FME engine 200 to fetch 24×24 pixels because of 8 tap filtering required in FME which translates to 24×24/8×4=18 8×4 blocks. This may be easily scalable to support AV1 codec prediction units such as, for example, 64×128, 128×64 and/or 128×128, etc. The table below captures the pixel data request size and the number of 8×4 blocks that may be fetched for the VP9 codec.

TABLE 1

| | VP9 Pixel | Number of |
|---|---|---|
| | data size (8 tap) | 8 × 4 blocks |
| 4 × 4 | 16 × 16 (12 × 12 | 8 (16 × 16/8 × 4) |
| | aligned | |
| | to 16 × 16) | |
| 8 × 8 | 16 × 16 | 8 (16 × 16/8 × 4) |
| 16 × 8 | 24 × 16 | 12 (24 × 16/8 × 4) |
| 8 × 16 | 16 × 24 | 12 (16 × 24/8 × 4) |
| 16 × 16 | 24 × 24 | 18 (24 × 24/8 × 4) |
| 16 × 32 | 24 × 40 | 30 (24 × 40/8 × 4) |
| 32 × 16 | 40 × 24 | 30 (40 × 24/8 × 4) |
| 32 × 32 | 40 × 40 | 50 (40 × 40/8 × 4) |
| 32 × 64 | 40 × 72 | 90 (40 × 72/8 × 4) |
| 64 × 32 | 72 × 40 | 90 (72 × 40/8 × 4) |
| 64 × 64 | 72 × 72 | 162 (72 × 72/8 × 4) |

Similarly, the number of reference frames for unidirectional prediction and number of reference frame pairs and number of iterations per reference frame pair may be fully programmable by the Src & Ref Pixel Read module 202. This may be important to make the design architecture scalable because complex codecs like AV1 provide support for more reference frames and pairs than VP9.

### Hardware Friendly Bi-Prediction Process

To simplify hardware while meeting the high throughput requirements, the exemplary embodiments may utilize a unified hardware-friendly process/algorithm described below which may support multiple codecs. These optimizations of utilizing the unified hardware-friendly process/algorithm may have a minimal impact on quality.

### Exemplary Bi-Prediction Process: VP9 Codec

Described below is a bi-prediction process for a video codec such as, for example VP9.

In this exemplary embodiment, there are a total of 7 iterations (e.g., 3 iterations for unidirectional prediction (LF, GF, ARF) and 2 iterations of LF+ARF, 2 iterations of GF+ARF where LF-Last Frame, GF-Golden Frame and ARF-Alternate Reference Frame.
LFi->Integer MV in LF
LFh->Half Pixel MV in LF
LFq->Quarter Pixel MV in LF
LFe->One-Eighth Pixel MV in LF

### Unidirectional Predictions:

Iteration 0: LFi->LFh->LFq->LFe
Iteration 1: ARFi->ARFh->ARFq->ARFe
Iteration 2: GFi->GFh->GFq->GFe

In an exemplary embodiment, the pipelined Half-Pixel Intp module 204, the Quarter-Pixel Interpolation module 206 and the One-Eight-Pixel Interpolation module 208 may perform the unidirectional predictions. The pipelined Half-Pixel Intp module 204 may determine half pixel interpolation denoted as LFh, GFh and ARFh. Similarly, the Quarter-Pixel Interpolation module 206 may determine the Quarter Pixel interpolations denoted as LFq, GFq, ARFq. The One-Eight-Pixel Interpolation module 208 may determine the eighth pixel interpolations denoted as LFe, GFe and ARFe. The result of the determinations may be utilized by the Bi-Prediction Frame Recompute module 210 as input to determine bi-directional prediction.

### Compound Prediction Iterations (Performed by the Bi-Prediction Frame Recompute Module 210):

Iteration 3: 1^{st} Ref Frame=LFe (updated from Iteration 0), 2^{nd} Ref Frame=ARFi (LFe+ARFi)/2->(LFe+ARFh)/2->(LFe+ARFq)/2->(LFe+ARFe)/2
Iteration 4: 1^{st} Ref Frame=ARFe (updated from iteration 1), 2^{nd} Ref Frame=LFi (ARFe+LFi)/2->(ARFe+LFh)/2->(ARFe+LFq)/2->(ARFe+LFe)/2
Iteration 5: 1^{st} Ref Frame=GFe (updated from Iteration 0), 2^{nd} Ref Frame=ARFi (GFe+ARFi)/2->(GFe+ARFh)/2->(GFe+ARFq)/2->(GFe+ARFe)/2
Iteration 6: 1^{st} Ref Frame=ARFe (updated from iteration 1), 2^{nd} Ref Frame=GFi (ARFe+GFi)/2->(ARFe+GFh)/2->(ARFe+GFq)/2->(ARFe+GFe)/2Sdfdsf

These above iterations determined by the bi-prediction frame recompute module 210 may be utilized to perform an averaging operation. For example, (LFe+ARFi)/2 is the averaging of LFe (Last Frame eighth pixel interpolation) and ARFi (Alternate Reference Frame integer pixel). As described above, these interpolations and averaging are determined by the bi-prediction frame recompute module 210.

In FIG. 2, input to unidirectional prediction is the input Integer MV and Src/Pixel data. The output of the unidirectional prediction at the One-Eight-Pixel Interpolation module 208 may be provided back as input to the Src & Ref Pixel Read module 202. This feedback loop may produce the input pixel data given to the bi-prediction frame recompute module 210.

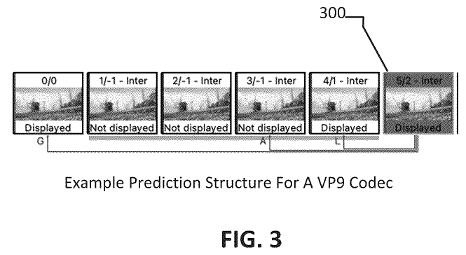

Referring now to FIG. 3, a diagram illustrating frames associated with the bi-prediction structure determination relating to the VP9 codec is provided according to an exemplary embodiment. FIG. 3 illustrates an exemplary structure of reference frames (e.g., LF, GF and ARF). In FIG. 3, the 5/2 frame 300 is able to utilize three frames (e.g., LF, GF, ARF) as reference frames. Since the 5/2 frame 300 has access to multiple frames, bi-directional prediction may be determined by the Bi-Prediction Frame Recompute module 210.

### Memory Optimization

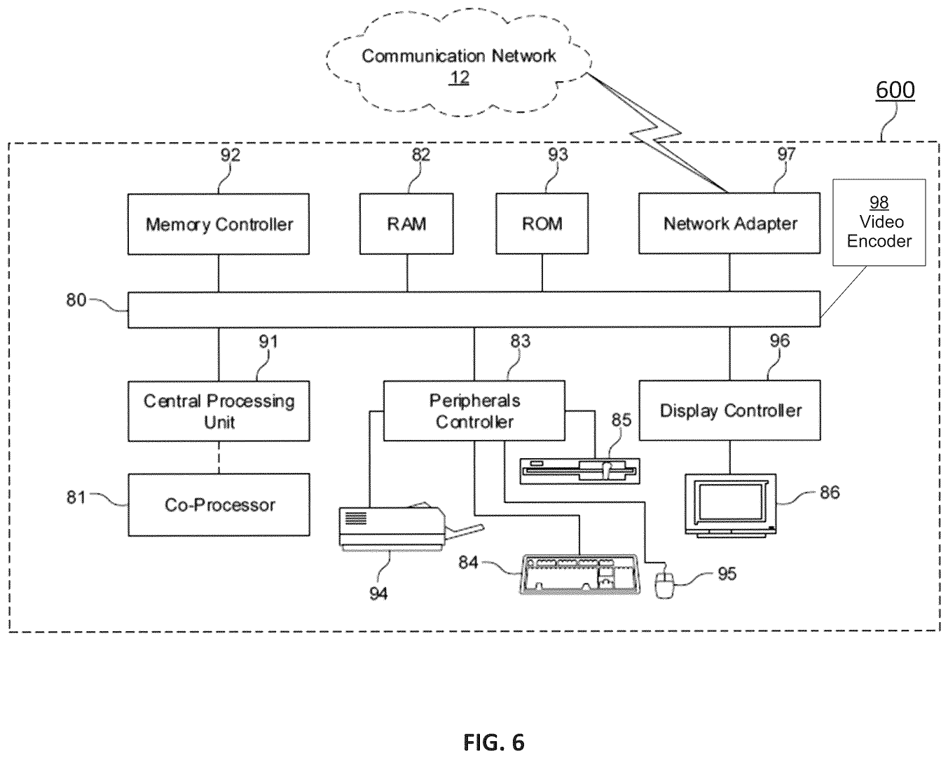

As shown in the fractional motion estimation engine 200 of FIG. 2, the fractional motion estimation engine 200 includes a bi-prediction frame recompute module 210. The bi-prediction frame recompute module 210 recomputes one of the reference frames (e.g., the 1st reference frame above in the VP9 bi-prediction example) required for bi-prediction on the fly (e.g., in real-time) using the motion vector information from the unidirectional prediction determination. This approach reduces the memory footprint (e.g., conserve memory space) of a memory device (e.g., RAM 82 of FIG. 6) by avoiding the need to save reference pixels for all fractional motion vectors (e.g., half, quarter and one-eight) for an entire superblock during unidirectional prediction which may require a large memory footprint. The bi-prediction frame recompute module 210 may only be enabled during bi-prediction operation. This bi-prediction frame recompute approach of the exemplary embodiments may also make design scalable compared to just storing all samples in a memory device as the memory requirement may increase for newer video codecs due to larger prediction unit sizes.

### Exemplary Bi-Prediction Process: H.264 Codec

In an H.264 implementation, reference frames may be divided into reference lists—L0 and L1. In a typical example scenario, 3 reference frames belong to reference list L0 and a remaining 2 reference frames belong to reference list L1. For bi-prediction, all combinations of one frame from L0 and another frame from L1 may be used, by the bi-prediction frame recompute module 210, resulting in a total of 6 combinations, for example as shown below.
L0_ref_frame0+L1_ref_frame0
L0_ref_frame1+L1_ref_frame0
L0_ref_frame2+L1_ref_frame0
L0_ref_frame0+L1_ref_frame1
L0_ref_frame1+L1_ref_frame1
L0_ref_frame2+L1_ref_frame1

For each combination of reference frames, there are two iterations similar to the bi-prediction approach for the VP9 codec:

### Iteration 1:

(L0_ref_frame0_q+L1_ref_frame1_i)/2->(L0_ref_frame0_q+L1_ref_frame1_h)/2->(L0_ref_frame0_q+L1_ref_frame1_q)/2

### Iteration 2:

(L1_ref_frame0_q+L0_ref_frame1_i)/2->(L1_ref_frame0_q+L0_ref_frame1_h)/2->(L1_ref_frame0_q+L0_ref_frame1_q)/2

These iterations may be repeated for 6 pairs of reference frames by the bi-prediction frame recompute module 210.

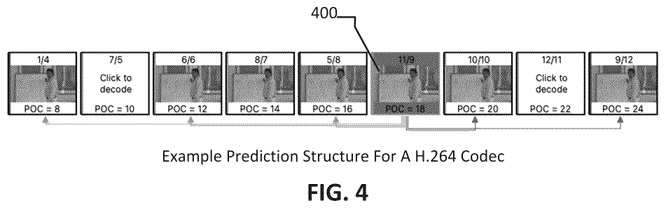

Referring now to FIG. 4, a diagram illustrating frames associated with the bi-prediction structure determination relating to the H.264 codec is provided according to an exemplary embodiment. Similar to FIG. 3 which illustrates a VP9 prediction structure, FIG. 4 illustrates an example prediction structure in H.264. The image 400 (e.g., image 11/9) in the diagram of FIG. 4 may utilize multiple reference frames as indicated by the arrows which may denote using bi-directional prediction determined by the bi-prediction frame recompute module 210.

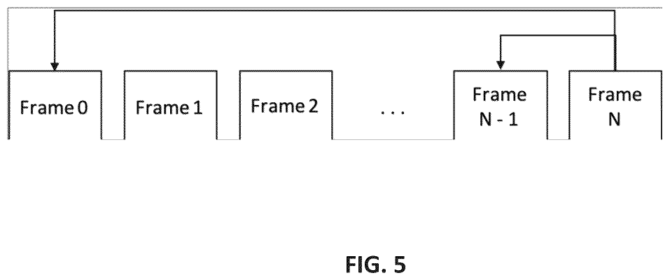

Referring now to FIG. 5, a diagram illustrating a manner in which two frames may be used for bi-prediction is shown according to an exemplary embodiment. The two frames (e.g., image frames) may both be from the past, or both may be from the future, or one frame from the past and one frame from the future. For example, as shown in FIG. 5, Frame N may be predicted from Frame 0 and Frame N−1. In some exemplary embodiments, the bi prediction frame recompute module 210 may perform this bi-prediction.

### Exemplary Computing System

FIG. 6 is a block diagram of an exemplary computing system 600. In some exemplary embodiments, the computing system 600 may include a video encoder 98. In some example embodiments, the video encoder 98 may be an example of video encoder 100. The computing system 600 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 600 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 600 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 600 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 700. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 600 may contain communication circuitry, such as for example a network adaptor 97, that may be used to connect computing system 600 to an external communications network, such as network 12 of FIG. 6, to enable the computing system 600 to communicate with other nodes of the network.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving one or more source pixels and reference pixels, wherein the source pixels are associated with one or more source image frames and the reference pixels are associated with one or more reference image frames;
utilizing motion vector information associated with the source pixels and the reference pixels to determine a plurality of fractional image samples associated with the one or more source image frames and the one or more reference image frames;
determining, based on the motion vector information, a unidirectional prediction relating to a motion estimation of at least one of the references image frames; and
determining, based on the unidirectional prediction, a bi-prediction motion estimate associated with the at least one reference image frame.

2. The method of claim 1, wherein the plurality of fractional images samples comprises at least one of a half-pixel position, a quarter pixel position or a one-eighth pixel position.
